(19) United States
(12) Patent Application Publication
(10) Pub. No.: US 2017/0033461 A1
(43) Pub. Date: Feb. 2, 2017

(54) LOW-PROFILE ANTENNA WITH HIGH ISOLATION FOR BLUETOOTH AND WIFI COEXISTENCE

(71) Applicant: QUALCOMM Incorporated, San Diego, CA (US)

(72) Inventors: Mehrbod Mohajer Jasebi, San Jose, CA (US); Eran Dor, Sunnyvale, CA (US)

(21) Appl. No.: 14/810,028

(22) Filed: Jul. 27, 2015

(51) Int. Cl. H01Q 5/385; H01Q 1/38; H01Q 5/50; H01Q 9/04

(52) U.S. Cl. CPC H01Q 5/385; H01Q 9/0407; H01Q 1/38; H01Q 5/50

(57) ABSTRACT

A low-profile, planar antenna structure includes a planar dielectric substrate, a ground plane disposed on an underside of the planar dielectric substrate; a circular planar radiating element disposed on an upper side of the planar dielectric substrate; and four arc-shaped parasitic elements evenly spaced apart and surrounding the circular planar radiating element, the four-arc shaped parasitic elements and the circular planar radiating element configured to operate together as a first planar antenna, a second planar antenna, and a patch antenna. The planar antenna structure may include four notches formed in the circular planar radiating element and extending, from four respective evenly-spaced points on a circumference of the circular planar radiating element, radially inward toward a center of the circular planar radiating element.

### TECHNICAL FIELD

The example embodiments relate generally to antennas, and specifically to an antenna structure that allows for the coexistence of multiple antennas in a compact and low-profile structure.

### BACKGROUND OF RELATED ART

Wireless devices, such as access points (APs) and/or mobile stations (STAs), may employ multiple-input and multiple-output (MIMO) communication techniques to increase data throughput, to increase channel diversity, and/or to increase range. In general, MIMO may refer to the use of multiple antennas in a wireless device to achieve antenna diversity. Antenna diversity may allow the wireless device to transmit and/or receive signals using multiple spatial streams, which in turn may increase throughput and reduce the impact of multipath interference.

Antenna diversity may also allow the wireless device to communicate with other wireless devices using multiple communication protocols and/or using signals associated with different frequency bands. For example, a wireless device may exchange signals with other wireless devices using signals associated with a Bluetooth protocol, using signals associated with a Wi-Fi protocol, and/or using signals associated with another suitable protocol. For wireless devices having a small form factor (e.g., mobile devices such as smartphones), collocating multiple antennas in close proximity with each other may undesirably reduce the isolation between the multiple antennas, which in turn may degrade performance.

Thus, there is a need to improve the isolation between multiple collocated antennas without increasing the size of the antenna structure.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A compact and low-profile antenna structure is disclosed that may allow for the co-existence of multiple antennas simultaneously operating in one or more frequency bands and/or according to one or more wireless communication protocols. For an example embodiment, the antenna structure comprises a ground plane; a circular planar radiating element disposed on the ground plane; and four arc-shaped parasitic elements evenly spaced apart and surrounding the circular planar radiating element, the four-arc shaped parasitic elements and the circular planar radiating element configured to simultaneously operate together as a first planar antenna, a second planar antenna, and a patch antenna. The four arc-shaped parasitic elements may be co-planar with and capacitively coupled to the circular planar radiating element. For some implementations, at least a portion of the circular planar radiating element is shared by the first planar antenna, the second planar antenna, and the patch antenna.

The antenna structure may include four notches formed in the circular planar radiating element and extending, from four respective evenly-spaced points on a circumference of the circular planar radiating element, radially inward toward a center of the circular planar radiating element. Each of the spaces between the four arc-shaped parasitic elements is aligned with a corresponding one of the four notches.

For some implementations, the first planar antenna is configured to transmit or receive Bluetooth signals; the second planar antenna is configured to transmit or receive Wi-Fi signals in a first frequency band; and the patch antenna is configured to transmit or receive Wi-Fi signals in a second frequency band that is different than the first frequency band. For some implementations, the first frequency band may be a 2.4 GHz band, and the second frequency band may be a 5 GHz band. For other implementations, the first and second frequency bands may be associated with other frequency ranges.

For other implementations, the first planar antenna is configured to transmit or receive first Wi-Fi signals in the 2.4 GHz band; the second planar antenna is configured is configured to transmit or receive second Wi-Fi signals in the 2.4 GHz band; and the patch antenna is configured to transmit or receive Wi-Fi signals in the 5 GHz band.

### BRIEF DESCRIPTION OF THE DRAWINGS

The example embodiments are illustrated by way of example and are not intended to be limited by the figures of the accompanying drawings, where:

FIG. 1A depicts a radiation pattern of a vertically polarized dipole antenna.

FIG. 1B depicts a radiation pattern of a horizontally polarized dipole antenna.

FIG. 2A shows an elevated perspective view a planar antenna structure in accordance with example embodiments.

FIGS. 2B and 2C show top plan views of the planar antenna structure of FIG. 2A.

FIG. 2D shows a bottom plan view of the planar antenna structure of FIG. 2A.

FIG. 3 depicts an example return loss associated with the ports of the planar antenna structure of FIGS. 2A-2D.

FIG. 4A depicts an example isolation between ports of the planar antenna structure of FIGS. 2A-2D associated with different frequency bands.

FIG. 4B depicts an example isolation between ports of the planar antenna structure of FIGS. 2A-2D associated with a similar frequency band.

FIG. 5 depicts a three-dimensional radiation pattern of the first planar antenna of the planar antenna structure of FIGS. 2A-2D.

FIG. 6 depicts a three-dimensional radiation pattern of the second planar antenna of the planar antenna structure of FIGS. 2A-2D.

FIG. 7 depicts a three-dimensional radiation pattern of the patch antenna of the planar antenna structure of FIGS. 2A-2D.

FIG. 8 shows a block diagram of a wireless network within which the example embodiments may be implemented.

FIG. 9 shows a block diagram of a wireless device within which the example embodiments may be implemented.

FIG. 10 is an illustrative flow chart depicting an example method for constructing the planar antenna structure of FIGS. 2A-2D.

Like reference numerals refer to corresponding parts throughout the drawings.

### DETAILED DESCRIPTION

The example embodiments are discussed below in the context of antenna structures for Wi-Fi signals and Bluetooth signals for simplicity only. It is to be understood that the example embodiments are equally applicable to signals of other wireless communication technologies and/or standards. As used herein, the terms “WLAN” and “Wi-Fi®” may include communications governed by the IEEE 802.11 family of standards, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. The term “Bluetooth®” (hereinafter referred to as Bluetooth or “BT”) may include communications governed by the IEEE 802.15 family of standards and/or communications governed by the Bluetooth Special Interest group.

In the following description, numerous specific details are set forth such as examples of specific components, circuits, and processes to provide a thorough understanding of the example disclosure. The term “coupled” as used herein means connected directly to or connected through one or more intervening components or circuits.

The terms “horizontal plane” and “azimuth plane,” as used herein, are interchangeable and refer to the two-dimensional plane parallel to the surface of the Earth (e.g., as defined by an x-axis and a y-axis). The term “vertical plane,” as used herein, refers to a two-dimensional plane perpendicular to the horizontal plane (e.g., symmetrical about a z-axis).

The term “radiation pattern,” as used herein, refers to a geometric representation of the relative electric field strength as emitted by a transmitting antenna at different spatial locations. For example, a radiation pattern may be represented pictorially as one or more two-dimensional cross sections of the three-dimensional radiation pattern. Because of the principle of reciprocity, it is known that an antenna has the same radiation pattern when used as a receiving antenna as it does when used as a transmitting antenna. Therefore, the term radiation pattern is understood herein to also apply to a receiving antenna, where it represents the relative amount of electromagnetic coupling between the receiving antenna and an electric field at different spatial locations. Thus, the term “omni-directional radiation pattern in the azimuth plane,” as used herein, means a radiation pattern that covers all angles of incidence on the horizon.

The term “polarization,” as used herein, refers to a spatial orientation of the electric field produced by a transmitting antenna, or alternatively the spatial orientation of electrical and magnetic fields causing substantially maximal resonance of a receiving antenna. For example, in the absence of reflective surfaces, a dipole antenna radiates an electric field that is oriented parallel to the radiating bodies of the antenna. The term “horizontally polarized,” as used herein, refers to electromagnetic waves (e.g., RF signals) associated with an electric field (E-field) that oscillates in the horizontal direction (e.g., side-to-side in the horizontal plane), and the term “vertically polarized,” as used herein, refers to electromagnetic waves (e.g., RF signals) associated with an E-field that oscillates in the vertical direction (e.g., up and down in the vertical plane).

Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the example disclosure. The example embodiments are not to be construed as limited to specific examples described herein but rather to include within their scopes all embodiments defined by the appended claims.

For purposes of convenience and clarity only, directional terms, such as top, bottom, left, right, up, down, over, above, below, beneath, rear, back, front, and across may be used with respect to the accompanying drawings or particular embodiments. These and similar directional terms should not be construed to limit the scope of the disclosure in any manner and may change depending upon context. Further, sequential terms such as first and second may be used to distinguish similar elements, but may be used in other orders or may also change depending upon context.

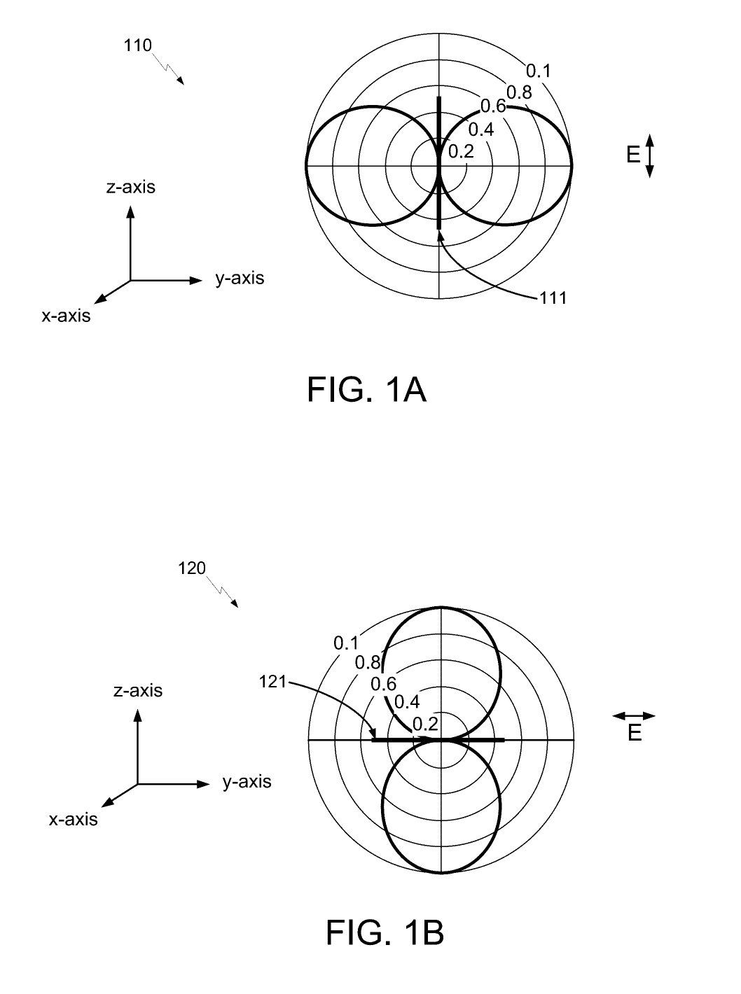

FIG. 1A shows a cross-sectional view of a radiation pattern 110 of a typical vertically polarized dipole antenna 111 that extends in a vertical direction along the z-axis. The radiation pattern 110 is a toroid that is symmetrical about the z-axis and is omni-directional in the horizontal plane (e.g., as defined by the x-axis and the y-axis). More specifically, the radiation pattern 110 has maximum gains in the horizontal plane and has nulls in the vertical direction extending from each end of antenna 111. As a result, antenna 111 may receive signals originating from the horizon, and may not receive signals originating from the vertical direction (e.g., because of the nulls extending from the axis of the antenna 111). Further, because antenna 111 is vertically polarized, antenna 111 may capture only the vertically polarized components of received signals. Thus, although antenna 111 has an omni-directional radiation pattern 110 in the horizontal plane, antenna 111 may not receive horizontally polarized signals originating from the horizon.

FIG. 1B shows a cross-sectional view of a radiation pattern 120 of a typical horizontally polarized dipole antenna 121 that extends in a horizontal direction (e.g., along the y-axis). The radiation pattern 120 is a toroid that is symmetrical about the y-axis and is omni-directional in the vertical plane. More specifically, the radiation pattern 120 has maximum gains in the vertical plane and has nulls in the horizontal plane in a direction extending from each end of antenna 121 (e.g., along the y-axis). As a result, antenna 121 may not receive signals originating from paths on the horizon along the y-axis. Further, because antenna 121 is horizontally polarized, antenna 121 may capture only the horizontally polarized components of received signals. Thus, although antenna 121 has an omni-directional radiation pattern 120 in the vertical plane, antenna 121 may not receive vertically polarized signals.

Further, although the vertically polarized antenna 111 and the horizontally polarized antenna 121 may be arranged together in a cross-configuration, the resulting cross dipole antenna structure may not be able to transmit/receive horizontally polarized signals to/from all angles on the horizon (although it may be able to transmit/receive vertically polarized signals to/from all angles on the horizon). Note that the descriptions above with respect to FIGS. 1A-1B are merely illustrative, and are not intended to represent radiation patterns associated with the example embodiments.

When multiple antennas are collocated on the same device, undesirable coupling between the multiple antennas may cause the multiple antennas to interfere with each other. For example, if antenna 111 of FIG. 1A and antenna 121 of FIG. 1B are adjacent to one another, then the vertically polarized antenna 111 may undesirably radiate some horizontally polarized signals (e.g., thereby interfering with the reception of horizontally polarized signals by the horizontally polarized antenna 121), and the horizontally polarized antenna 121 may undesirably radiate some vertically polarized signals (e.g., thereby interfering with the reception of vertically polarized signals by the vertically polarized antenna 111). Thus, when multiple antennas are collocated on a wireless device, it is desirable to isolate the multiple antennas from each other (e.g., to reduce interference between the multiple antennas) while reducing the overall size and/or space consumed by the antennas. These are at least some of the technical problems to be solved by the example embodiments.

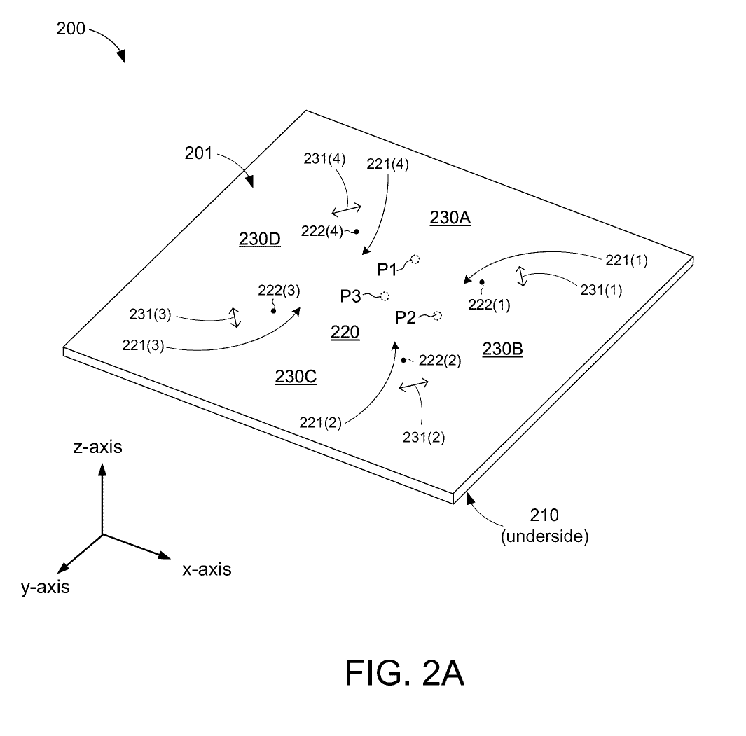

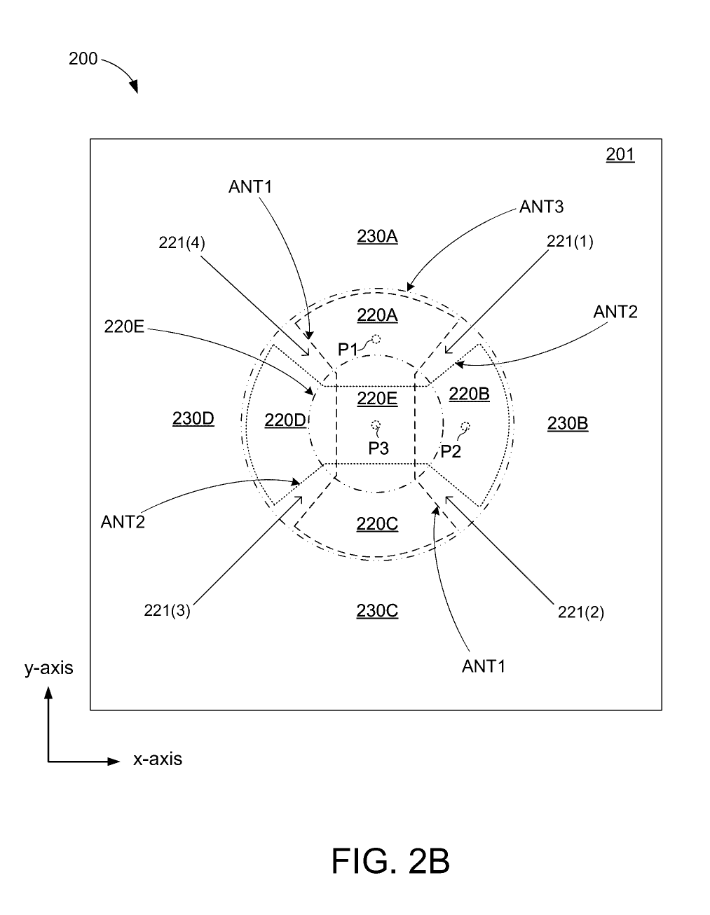

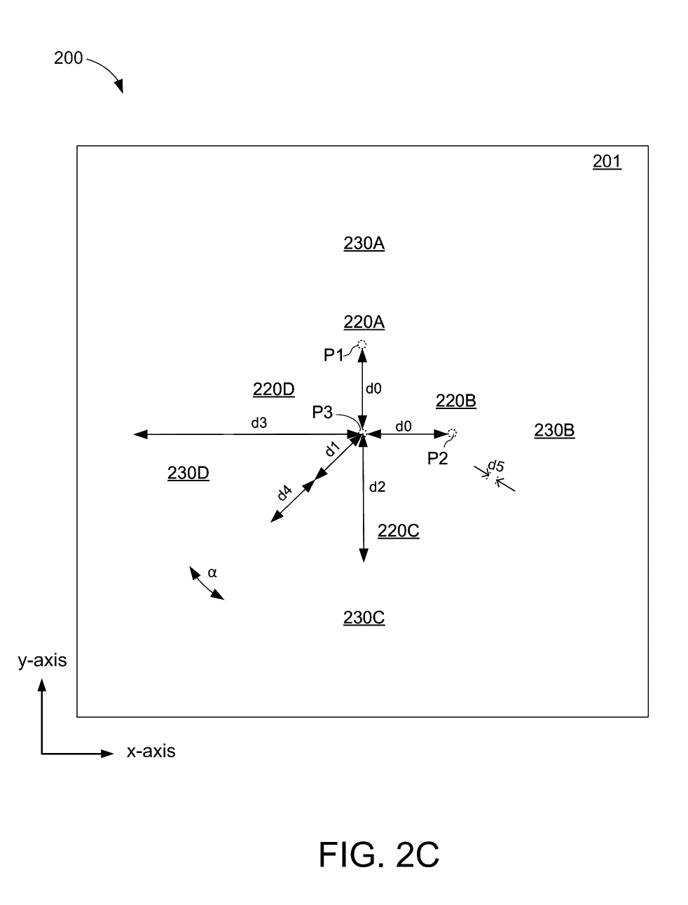

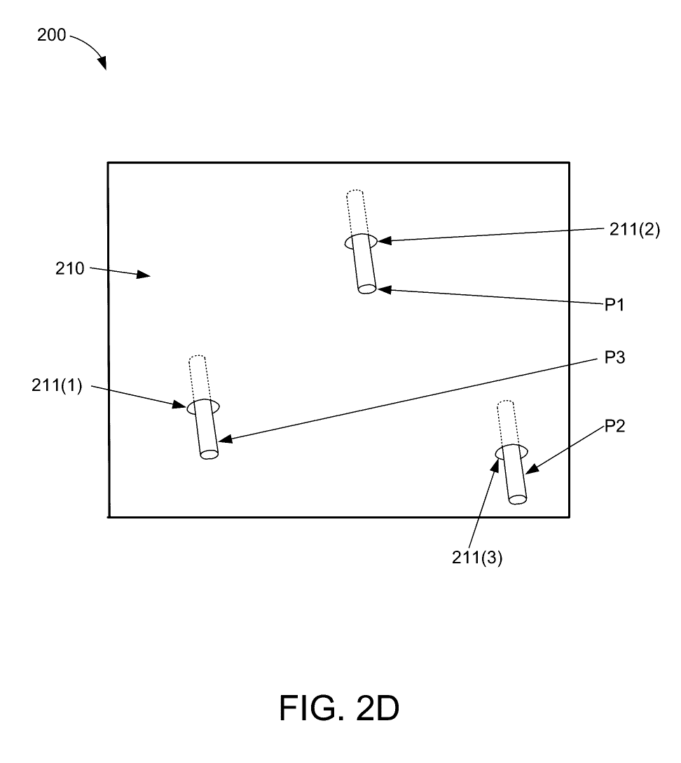

FIG. 2A shows an elevated perspective view of a planar antenna structure 200 in accordance with the example embodiments. The planar antenna structure 200 may be included within or attached to any suitable host wireless device, for example, to transmit wireless signals to other wireless devices and/or to receive wireless signals from other wireless devices (the host wireless device and the other wireless devices are not shown in FIG. 2A for simplicity). The planar antenna structure 200 may be formed on a dielectric substrate 201. As shown, planar antenna structure 200 may include a ground plane 210, a circular planar radiating element 220, four arc-shaped parasitic elements 230A-230D, and three excitation ports P1-P3. The three excitation ports P1-P3 may provide signals to and/or receive signals from three corresponding antennas ANT1-ANT3 integrated within the planar antenna structure 200, as described in more detail below with respect to FIG. 2B.

The ground plane 210 may be formed of any suitable material that provides a grounding and/or reflective surface for antenna structure 200. For example embodiments, the ground plane 210 may be formed from a conductive metal. In some embodiments, the ground plane 210 and the other antenna elements may be formed on the dielectric substrate 201 which may be, for example, an FR4 substrate, having a thickness of approximately 1.5 mm (although for other embodiments, the dielectric substrate 201 may be of another suitable thickness). In some embodiments, the ground plane 210 may have a thickness of approximately 17 μm or 32 μm (although for other embodiments, the ground plane 210 may be of another suitable thickness).

The circular planar radiating element 220 and the four arc-shaped parasitic elements 230A-230D may be formed of any suitable conductive material. For example, the circular planar radiating element 220 and the four arc-shaped parasitic elements 230A-230D may be formed from a conductive metal having a thickness of approximately 17 μm or 32 μm (although in some other embodiments these components may be of another suitable thickness). For at least some example embodiments, the ground plane 210, the circular planar radiating element 220 and the four arc-shaped parasitic elements 230A-230D may be conductive films printed onto or otherwise disposed on the substrate 201.

The planar antenna structure 200 includes four notches 221(1)-221(4) formed in the circular planar radiating element 220. The four notches 221(1)-221(4) extend, from four respective evenly-spaced points or locations 222(1)-222(4) on the circumference of the circular planar radiating element 220, radially inward toward a center of the circular planar radiating element 220. Referring also to FIG. 2B, the four notches 221(1)-221(4) may define four exterior regions 220A-220D and a substantially circular interior region 220E of the circular planar radiating element 220. For example, notch 221(1) may separate portions of exterior regions 220A-220B from each other, notch 221(2) may separate portions of exterior regions 220B-220C from each other, notch 221(3) may separate portions of exterior regions 220C-220D from each other, and notch 221(4) may separate portions of exterior regions 220D-220A from each other.

The four arc-shaped parasitic elements 230A-230D may be of the same size and shape, and may be positioned around a circumference of the circular planar radiating element 220. Thus, as depicted in FIGS. 2A-2B, the four arc-shaped parasitic elements 230A-230D surround the circular planar radiating element 220. The four arc-shaped parasitic elements 230A-230D are capacitively coupled to circular planar radiating element 220, and may be aligned with the four exterior regions 220A-220D, respectively, of the circular planar radiating element 220. For example, the first arc-shaped parasitic element 230A is aligned with and capacitively coupled to the first exterior region 220A of circular planar radiating element 220, the second arc-shaped parasitic element 230B is aligned with and capacitively coupled to the second exterior region 220B of circular planar radiating element 220, the third arc-shaped parasitic element 230C is aligned with and capacitively coupled to the third exterior region 220C of circular planar radiating element 220, and the fourth arc-shaped parasitic element 230D is aligned with and capacitively coupled to the fourth exterior region 220D of circular planar radiating element 220.

The four arc-shaped parasitic elements 230A-230D are evenly spaced apart from each other, and the spaces between the four arc-shaped parasitic elements 230A-230D may be aligned with corresponding notches 221 formed in the circular planar radiating element 220. More specifically, for the example embodiment depicted in FIG. 2A, a first space 231(1) separating parasitic elements 230A-230B is aligned with the first notch 221(1), a second space 231(2) separating parasitic elements 230B-230C is aligned with the second notch 221(2), a third space 231(3) separating parasitic elements 230C-230D is aligned with the third notch 221(3), and a fourth space 231(4) separating parasitic elements 230D-230A is aligned with the fourth notch 221(4).

In accordance with the example embodiments, the circular planar radiating element 220 and the four-arc shaped parasitic elements 230A-230D may form (and together simultaneously operate as) two planar antennas and a patch antenna. More specifically, referring to FIG. 2B, a first contiguous area of circular planar radiating element 220 that may include interior region 220E and exterior regions 220A and 220C may form and operate as at least part of a first planar antenna ANT1, a second contiguous area of circular planar radiating element 220 that may include interior region 220E and exterior regions 220B and 220D may form and operate as at least part of a second planar antenna ANT2, and a substantial portion of circular planar radiating element 220 may form and operate as at least part of a patch antenna ANT3. For the example embodiments described herein, the first planar antenna ANT1, the second planar antenna ANT2, and the patch antenna ANT3 may share at least the interior region 220E of circular planar radiating element 220. Thus, as described in more detail below, the first planar antenna ANT1, the second planar antenna ANT2, and the patch antenna ANT3 may be embodied (e.g., integrated together) within the circular planar radiating element 220 and the four-arc shaped parasitic elements 230A-230D. By using common portions of the circular planar radiating element 220 and the four arc-shaped parasitic elements 230A-230D to form and operate as three separate antennas ANT1-ANT3, the area consumed by the planar antenna structure 200 of the example embodiments may be reduced (e.g., compared with conventional 3-antenna structures).

The first planar antenna ANT1 may be excited by first excitation port P1, which is located at a point in first exterior region 220A approximately equidistant between notches 221(1) and 221(4) in a direction along the x-axis and approximately equidistant between interior region 220E and the circumference of circular planar radiating element 220 in a direction along the y-axis. More specifically, the first planar antenna ANT1 may transmit (e.g., radiate) first wireless signals to other wireless devices based on first excitation signals provided by first excitation port P1, and may provide wireless signals received (e.g., captured) from other wireless devices to first excitation port P1. The parasitic elements 230A and 230C, which as mentioned above are capacitively coupled to respective exterior regions 220A and 220C of the circular planar radiating element 220, may form part of the first planar antenna ANT1 and/or may determine, at least in part, a frequency bandwidth associated with the first planar antenna ANT1.

For example, when first planar antenna ANT1 is excited by first excitation signals provided by first excitation port P1, regions of circular planar radiating element 220 operating as the first planar antenna ANT1 may radiate electromagnetic waves (e.g., RF signals) into free space. In addition, currents flowing along the outer edges of exterior regions 220A and 220C in response to the first excitation signals may excite parasitic elements 230A and 230C, respectively, which in turn may also radiate RF signals into free space. Thus, the radiation pattern of the first planar antenna ANT1 may be determined by geometries of circular planar radiating element 220 and parasitic elements 230A and 230C.

The second planar antenna ANT2 may be excited by second excitation port P2, which is located at a point in second exterior region 220B approximately equidistant between notches 221(1) and 221(2) in a direction along the y-axis and approximately equidistant between interior region 220E and the circumference of circular planar radiating element 220 in a direction along the x-axis. More specifically, the second planar antenna ANT2 may transmit (e.g., radiate) second wireless signals to other wireless devices based on second excitation signals provided by second excitation port P2, and may provide wireless signals received (e.g., captured) from other wireless devices to second excitation port P2. The parasitic elements 230B and 230D, which as mentioned above are capacitively coupled to respective exterior regions 220B and 220D of the circular planar radiating element 220, may form part of the second planar antenna ANT2 and/or may determine, at least in part, a frequency bandwidth associated with the second planar antenna ANT2.

For example, when second planar antenna ANT2 is excited by second excitation signals provided by second excitation port P2, regions of circular planar radiating element 220 operating as the second planar antenna ANT2 may radiate electromagnetic waves (e.g., RF signals) into free space. In addition, currents flowing along the outer edges of exterior regions 220B and 220D in response to the second excitation signals may excite parasitic elements 230B and 230D, respectively, which in turn may also radiate RF signals into free space. Thus, the radiation pattern of the second planar antenna ANT2 may be determined by geometries of circular planar radiating element 220 and parasitic elements 220B and 220D.

The patch antenna ANT3 may be excited by third excitation port P3, which is located at the center of the circular planar radiating element 220. More specifically, the patch antenna ANT3 may transmit (e.g., radiate) third wireless signals to other wireless devices based on third excitation signals provided by third excitation port P3, and may provide wireless signals received (e.g., captured) from other wireless devices to third excitation port P3. The parasitic elements 230A-230D, which as mentioned above are capacitively coupled to the circular planar radiating element 220, may form part of the patch antenna ANT3, for example, by operating as peripheral radiating elements of the patch antenna ANT3. In addition, the parasitic elements 230A-230D may determine, at least in part, a frequency bandwidth associated with the patch antenna ANT3 (e.g., and may also determine, at least in part, frequency bandwidths associated with the planar antennas ANT1-ANT2.

For example, when patch antenna ANT3 is excited by third excitation signals provided by third excitation port P3, regions of circular planar radiating element 220 operating as the patch antenna ANT3 may radiate electromagnetic waves (e.g., RF signals) into free space. In addition, currents flowing along the outer edges of exterior regions 220A-220D in response to the third excitation signals may excite parasitic elements 230A-230D, which in turn may also radiate RF signals into free space. Thus, the radiation pattern of the patch antenna ANT3 may be determined by geometries of circular planar radiating element 220 and parasitic elements 230A-230D.

FIG. 2C is a top plan view of the planar antenna structure 200 depicting example geometric relationships of various elements of the planar antenna structure 200. Specifically, the third excitation port P3 is located at the center of circular planar radiating element 220. The first excitation port P1 is located a distance d0 from the center of circular planar radiating element 220 along the y-axis, and the second excitation port P2 is located the distance d0 from the center of circular planar radiating element 220 along the x-axis. Because the first and second excitation ports P1 and P2 are positioned approximately 90 degrees apart on the circular planar radiating element 220, the first and second planar antennas ANT1 and ANT2 are orthogonally oriented, in the azimuth plane, with respect to each other. As described in more detail below, the orthogonal orientation of the first and second planar antennas ANT1 and ANT2 on the circular planar radiating element 220 may result in the first and second planar antennas ANT1 and ANT2 exhibiting radiation patterns that are similar in shape but orthogonally polarized. The orthogonal polarizations of the first and second planar antennas ANT1 and ANT2 may provide a relatively high degree of isolation between the first and second planar antennas ANT1 and ANT2.

The third excitation port P3, located at the center of the circular planar radiating element 220, is a distance d1 from the innermost point of each notch 221. The circular planar radiating element 220 has a radius denoted as a distance d2. The planar antenna structure 200 has a radius, measured from the center of circular planar radiating element 220 to an outer edge of parasitic elements 230, denoted as a distance d3. The notches 221 extend radially inward from a circumference of circular planar radiating element 220 by a distance d4. The parasitic elements 230 are separated from circular planar radiating element 220 by a distance d5, and are separated from each other by an angular width (a).

The four arc-shaped parasitic elements 230A-230D may alter the resonant frequencies associated with portions of antennas ANT1-ANT3 formed on the circular planar radiating element 220, for example, to increase the bandwidth of antennas ANT1-ANT3. The separation (a) between adjacent ones of the arc-shaped parasitic elements 230A-230D may also affect the bandwidth of antennas ANT1-ANT3. Thus, the bandwidth and/or frequency response of antennas ANT1-ANT3 may be adjusted by changing the distance between the arc-shaped parasitic elements 230A-230D.

For at least one example embodiment, the distance d1 may be approximately 8 millimeters (mm), the distance d2 may be approximately 15 mm, the distance d3 may be approximately 26.5 mm, the distance d4 may be approximately 7 mm, the distance d5 may be approximately 1 mm, and the value of a may be approximately 12 degrees. In addition, for at least one embodiment, the dielectric substrate 201 may have a thickness of approximately 1.5 mm. For purposes of this disclosure, the term “approximately” means that for actual embodiments, the values for distances d1-d5 and/or the values for a may each fall within a ±10% range centered about the corresponding distance specified herein. The ground plane 210, circular planar radiating element 220, and the four arc-shaped parasitic elements 230A-230D may each have a thickness of 17 μm or 32 μm (for other embodiments, the planar antenna structure 200 may have other dimensions, geometries, and/or relative distances between the various elements). Thus, because the planar antenna structure 200 has a very low profile (e.g., approximately 1.5 mm thick) and consumes a relatively small planar area (e.g., a circle having a radius of approximately 26.5 mm), the planar antenna structure 200 is suitable for use in wireless devices having a small form factor. In addition, as described in more detail below, the planar antenna structure 200 provides a relatively high degree of isolation between the first and second planar antennas ANT1-ANT2, and provides a relatively high degree of isolation between the planar antennas ANT1-ANT2 and the patch antenna ANT3, for example, due to the frequency separation between the first frequency band and the second frequency band. These relatively high degrees of isolation between three antennas ANT1-ANT3 may allow the three antennas ANT1-ANT3 to be collocated in the same structure and to operate simultaneously with relatively little interference from each other. These are at least some of the technical solutions provided by the example embodiments to the aforementioned technical problems.

As mentioned above, the planar antenna structure 200 may have dimensions, geometries, and/or relative distances between the various elements other than the examples described above. More specifically, for other embodiments, the dimensions of the planar antenna structure 200 may be altered (e.g., either increased or decreased) in a manner that may allow the planar antenna structure 200 to be utilized in a variety of devices having different form factors and/or operating in a number of different frequency bands. For one example implementation, the dimensions of the planar antenna structure 200 may be reduced so that the planar antenna structure 200 may be suitable for use in a mobile device (e.g., a smart phone or tablet). Reducing the dimensions of the planar antenna structure 200 may reduce the effective lengths of the first and second planar antennas ANT1-ANT2 and the patch antenna ANT3, which in turn may increase the radiation frequencies associated with each of the antennas ANT1-ANT3 (e.g., such that the first and second planar antennas ANT1-ANT2 may radiate at frequencies greater than those associated with 2.4 GHz signals, and the patch antenna ANT3 may radiate at frequencies greater than those associated with 5 GHz signals). The relative distances between the various elements and/or the geometries of the various elements may also be adjusted, for example, to maximize isolation between the antennas ANT1-ANT3.

For another example implementation, the dimensions of the planar antenna structure 200 may be increased so that the planar antenna structure 200 may be suitable for use in wireless devices having larger form factors. Increasing the dimensions of the planar antenna structure 200 may increase the effective lengths of the first and second planar antennas ANT1-ANT2 and the patch antenna ANT3, which in turn may decrease the radiation frequencies associated with each of the antennas ANT1-ANT3 (e.g., such that the first and second planar antennas ANT1-ANT2 may radiate at frequencies less than those associated with 2.4 GHz signals, and the patch antenna ANT3 may radiate at frequencies less than those associated with 5 GHz signals). The relative distances between the various elements and/or the geometries of the various elements may also be adjusted, for example, to maximize isolation between the antennas ANT1-ANT3.

FIG. 2D is a bottom perspective view of the planar antenna structure 200. For the example embodiment of FIG. 2D, each of excitation ports P1-P3 may extend in a downward direction beneath the ground plane 210 and may extend in an upward direction to a top surface of the circular planar radiating element 220 (see also FIGS. 2A-2C). The excitation ports P1-P3 may each be coupled to processing circuitry on the host wireless device via suitable connectors (for simplicity, the processing circuitry and connectors not shown in FIG. 2D). Suitable connectors may include (but not limited to) U.FL connectors, coaxial connectors, transmission lines with edge-mount connectors, and so on. As depicted in FIG. 2D, each of excitation ports P1-P3 may be disposed in a corresponding circular clearance 211 on ground plane 210. For example, the first excitation port P1 may be disposed in a first circular clearance 211(1), the second excitation port P2 may be disposed in a second circular clearance 211(2), and the third excitation port P3 may be disposed in a third circular clearance 211(3).

Referring again to FIGS. 2A-2B, the first planar antenna ANT1, the second planar antenna ANT2, and the patch antenna ANT3 may be embodied within the circular planar radiating element 220 and the four arc-shaped parasitic elements 230A-230D. Although all three antennas ANT1-ANT3 share circular interior region 220E of the circular planar radiating element 220, each of the three antennas ANT1-ANT3 may operate simultaneously and independently of one another. For example embodiments, the planar antennas ANT1-ANT2 may be configured to transmit/receive signals within a first frequency band, and the patch antenna ANT3 may be configured to transmit/receive signals within a second frequency band that is different than the first frequency band. For some implementations, the first frequency band may be a 2.4 GHz band, and the second frequency band may be a 5 GHz band. For other implementations, the first and second frequency bands may be associated with other frequency ranges.

For example, in one implementation, the first planar antenna ANT1 may be configured to transmit/receive Bluetooth signals (e.g., transmitted using frequency hopping techniques in a frequency band between approximately 2400 and 2484 MHz), the second planar antenna ANT2 may be configured to transmit/receive 2.4 G Wi-Fi signals (e.g., transmitted in the 2.4 GHz band between approximately 2400 and 2484 MHz), and the patch antenna ANT3 may be configured to transmit/receive 5 G Wi-Fi signals (e.g., transmitted in the 5 GHz band between approximately 4915 and 5825 MHz). In this manner, the planar antenna structure 200 may allow the host wireless device to simultaneously operate using Bluetooth signals, 2.4 G Wi-Fi signals, and 5 G Wi-Fi signals.

In another implementation, the first planar antenna ANT1 may be configured to transmit/receive 2.4 G Wi-Fi signals, the second planar antenna ANT2 may also be configured to transmit/receive 2.4 G Wi-Fi signals, and the patch antenna ANT3 may be configured to transmit/receive 5 G Wi-Fi signals. In this manner, the planar antenna structure 200 may allow the host wireless device to achieve multiple-input multiple-output (MIMO) functionality (e.g., in the 2.4 G Wi-Fi band) and operate as a dual-band wireless device (e.g., by operating in both the 2.4 G Wi-Fi band and the 5 G Wi-Fi band).

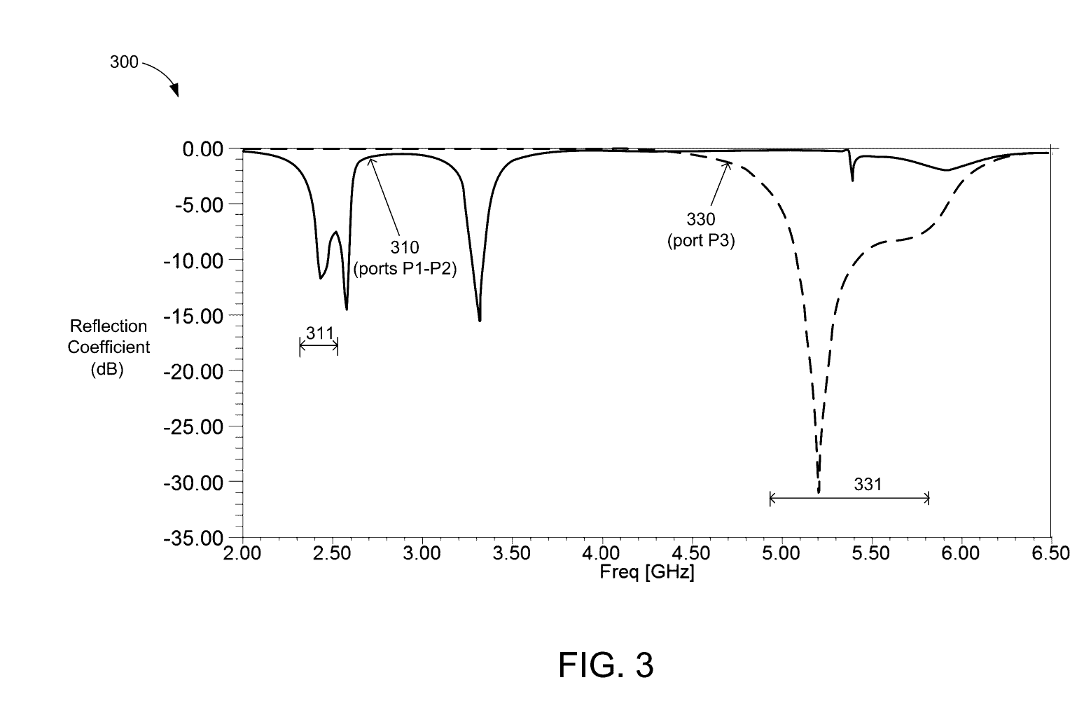

FIG. 3 is a graph 300 depicting an example reflection coefficient (in decibels, as a function of frequency) associated with the three excitation ports P1-P3 of the planar antenna structure of FIGS. 2A-2D. The reflection coefficient may be an important measure of antenna performance, for example, because an antenna's reflection coefficient indicates what proportion of the energy supplied to an excitation port is reflected back to the sender (e.g., an analog front-end of the host wireless device). A common measure of an antenna's reflection coefficient (RC) may be expressed in decibels (dB) as:

$$RC = 10 log \frac{Pr}{Pi} ,$$

wnere me term “Pr” indicates the amount of reflected power (e.g., the amount of power reflected from the antenna) and the term “Pi” indicates the amount of incident power (e.g., the amount of power supplied to the antenna). Thus, an effective antenna design should have a reflection coefficient that satisfies various requirements of the host device or system.

The example graph 300 includes a first curve 310 representing the reflection coefficient of the first and second excitation ports P1-P2, and includes a second curve 330 representing the reflection coefficient of the third excitation port P3. The reflection coefficient associated with the first and second excitation ports P1-P2 is the same or similar, for example, because of the symmetry between the first and second planar antennas ANT1-ANT2, respectively. As depicted in FIG. 3, the first and second planar antennas ANT1-ANT2, which are excited by corresponding excitation ports P1-P2, may achieve a bandwidth of approximately 200 MHz in the 2.4 GHz frequency band (the 200 MHz bandwidth is denoted in FIG. 3 as a region 311 in which the reflection coefficient for ports P1-P2 is less than approximately −6 dB). For one example implementation, ports P1-P2 may have a minimum reflection coefficient of approximately −15 dB at a frequency of approximately 2.58 GHz, as depicted in FIG. 3.

The patch antenna ANT3, which is excited by excitation port P3, may achieve a bandwidth of approximately 880 MHz in the 5 GHz frequency band (the 880 MHz bandwidth is denoted in FIG. 3 as a region 331 in which the return loss for port P3 is less than approximately −6 dB). For one example implementation, port P3 may have a minimum reflection coefficient of approximately −31 dB at a frequency of approximately 5.2 GHz, as depicted in FIG. 3.

As mentioned above, each of the three antennas ANT1-ANT3 may operate simultaneously and independently of one another, for example, because of the isolation provided between the three excitation ports P1-P3 (e.g., resulting from the unique structure and geometry of planar antenna structure 200). The planar antennas ANT1-ANT2 and the patch antenna ANT3 share at least some common portions of circular planar radiating element 220, and thus have minimal spatial diversity. Thus, providing a relatively high degree of isolation between the antennas ANT1-ANT3 is desired to reduce interference between the antennas ANT1-ANT3. More specifically, because the first and second planar antennas ANT1-ANT2 may operate in the same frequency band (e.g., the 2.4 GHz band), a relatively high degree of isolation—or, in other words, a relatively low amount of coupling—may be necessary between the first and second planar antennas ANT1-ANT2.

Referring also to FIGS. 2A-2D, the orthogonal orientation of the first planar antenna ANT1 with respect to the second planar antenna ANT2 may result in the first and second planar antennas ANT1-ANT2 having orthogonal polarizations. The resulting polarization diversity between the first and second planar antennas ANT1-ANT2 may provide sufficient isolation to allow for the co-existence and simultaneous operation of the first and second planar antennas ANT1-ANT2 in the same frequency band.

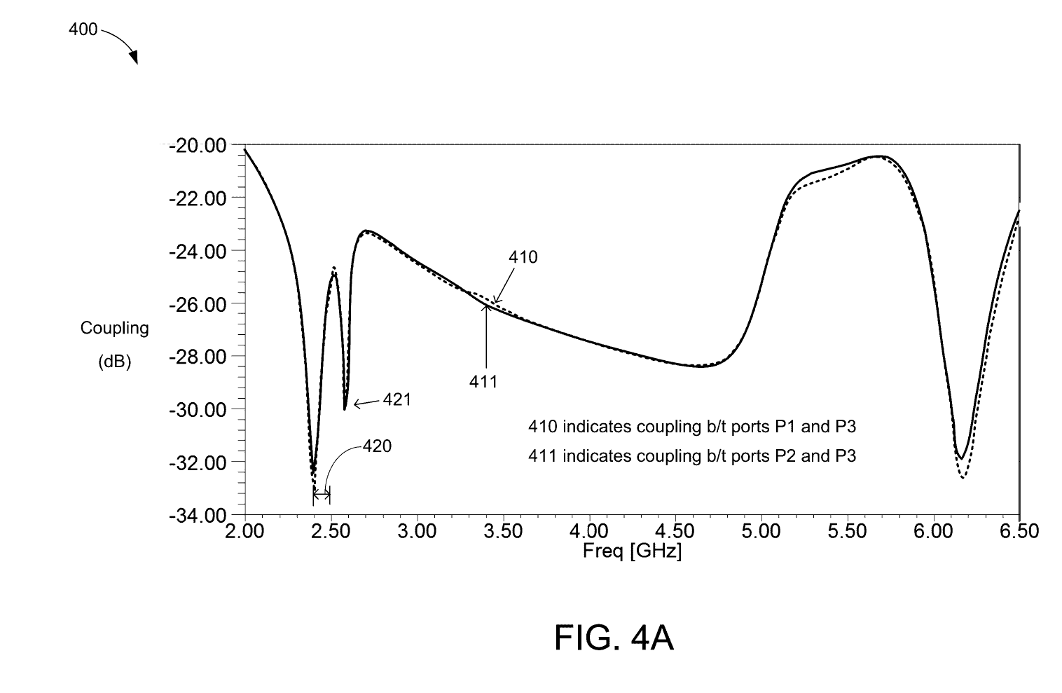

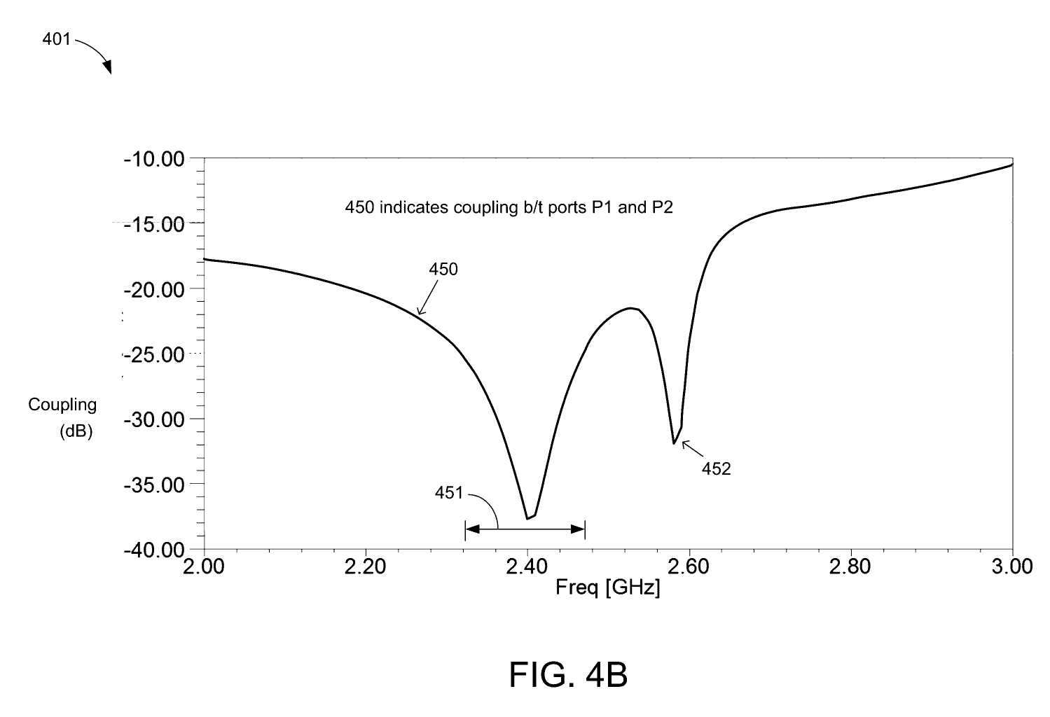

FIG. 4A shows a graph 400 depicting example coupling (in decibels, as a function of frequency) between ports P1/P2 and port P3 of the planar antenna structure 200. More specifically, the example graph 400 includes a first curve 410 representing the coupling between the first excitation port P1 and the third excitation port P3 (e.g., and thus curve 410 represents the coupling between first planar antenna ANT1 and patch antenna ANT3), and includes a second curve 411 representing the coupling between the second excitation port P2 and the third excitation port P3 (e.g., and thus curve 411 represents the coupling between second planar antenna ANT2 and patch antenna ANT3). Note that because the ports P1-P2 may have substantially similar responses (e.g., resulting from the similar structures of the two respective planar antennas ANT1-ANT2), curves 410 and 411 may be similar or the same.

As depicted in FIG. 4A, the coupling between the planar antenna ports P1/P2 and the patch antenna port P3 may be approximately −20 dB (or better) for the entire frequency spectrum between 2 GHz and 6.5 GHz. The coupling between the planar antenna ports P1/P2 and the patch antenna port P3 in the 2.4 GHz frequency band, denoted as 420 in FIG. 4A, may exceed −26 dB. This relatively high degree of isolation may allow antennas ANT1-ANT3 to be collocated on the same conductive element (e.g., circular planar radiating element 220) and to simultaneously operate in one or more frequency bands and/or using one or more wireless communication protocols. More specifically, this relatively high degree of isolation may allow planar antennas ANT1-ANT2 to operate in a relatively low frequency band (e.g., the 2.4 GHz band) while patch antenna ANT3 operates in a relatively high frequency band (e.g., the 5 GHz band). Further, because the second-order harmonics of 2.4 GHz signals may have frequency components in the 5 GHz band, providing approximately −20 dB of isolation between the 2.4 GHz ports (e.g., ports P1-P2) and the 5 GHz port (e.g., port P3) means that any undesirable second-order harmonics of the 2.4 GHz signals may have approximately 20 dB less power than the intended 5 GHz signals. It is noted that the relatively low coupling between the planar antenna ports P1/P2 and the patch antenna port P3 for frequencies near approximately 2.6 GHz, as denoted in FIG. 4A by arrow 421, may be outside the frequencies of interest (e.g., outside the frequency range between 2400 and 2484 MHz typically used by Wi-Fi and Bluetooth protocols).

FIG. 4B shows a graph 401 depicting an example coupling (in decibels, as a function of frequency) between ports P1 and P2 of the planar antenna structure 200. More specifically, the example graph 401 includes a curve 450 representing the coupling between the first excitation port P1 and the second port P2 (e.g., and thus curve 450 represents the coupling between first planar antenna ANT1 and second planar antenna ANT2). As depicted in FIG. 4B, the coupling between the planar antenna ports P1 and P2 may be approximately −25 dB (or better) for a frequency range between approximately 2.318 GHz and 2.470 GHz (e.g., denoted as a range 451 in FIG. 4B). The coupling between the planar antenna ports P1 and P2 may exceed −35 dB at frequencies near 2.4 GHz. This relatively high degree of isolation between the planar antenna ports P1 and P2 may allow the collocated planar antennas ANT1-ANT2 to simultaneously operate in the same frequency band (e.g., the 2.4 GHz band) with minimal co-existence interference. As a result, wireless devices including the planar antenna structure 200 may simultaneously communicate with other wireless devices using Bluetooth signals and 2.4 GHz Wi-Fi signals (or alternatively may implement 2×2 MIMO functionality with minimal co-existence interference between antennas ANT1-ANT2) using the compact and low-profile antenna structures of the example embodiments. It is noted that the relatively low coupling between the planar antenna ports P1 and P2 for frequencies near approximately 2.6 GHz, as denoted in FIG. 4B by arrow 452, may be outside the frequencies of interest (e.g., outside the frequency range between 2400 and 2484 MHz typically used by Wi-Fi and Bluetooth protocols).

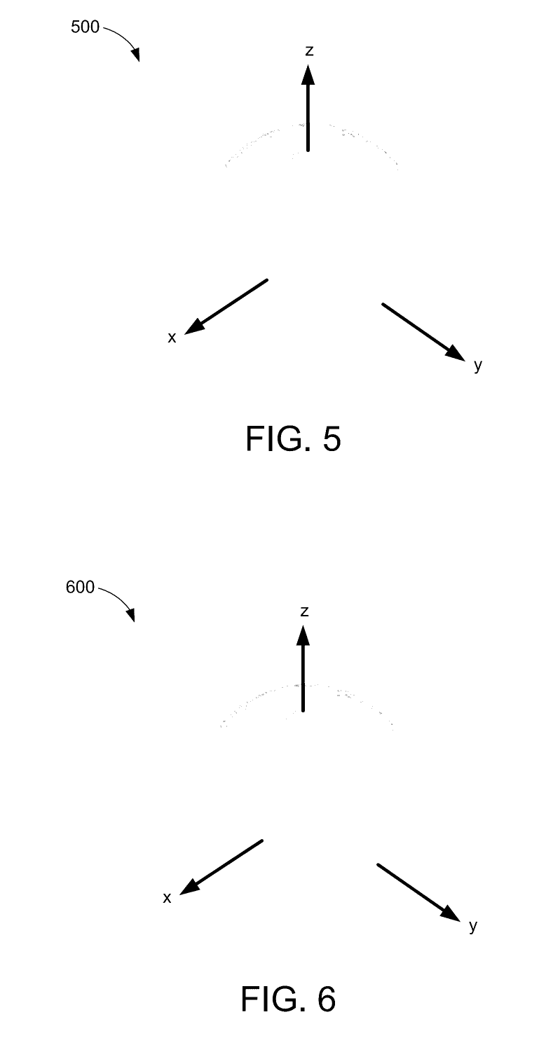

FIG. 5 depicts a three-dimensional radiation pattern 500 of the first planar antenna ANT1 of the planar antenna structure 200 of FIGS. 2A-2D. As depicted in FIG. 5, darker regions of pattern 500 correspond to larger gains. Thus, the first planar antenna ANT1 may have a peak gain in the normal direction (e.g., along the z-axis). For at least some embodiments, the first planar antenna ANT1 may have a peak gain of approximately 5.3 dBi and an efficiency of approximately 70% for the 2.4 GHz band (by comparison, efficiencies greater than 40% may be acceptable for many wireless communications).

FIG. 6 depicts a three-dimensional radiation pattern 600 of the second planar antenna ANT2 of the planar antenna structure 200 of FIGS. 2A-2D. As depicted in FIG. 6, darker regions of pattern 600 correspond to larger gains. Thus, the second planar antenna ANT2 may have a peak gain in the normal direction (e.g., along the z-axis). For at least some embodiments, the second planar antenna ANT2 may have a peak gain of approximately 5.3 dBi and an efficiency of approximately 70% for the 2.4 GHz band.

Note that although the respective radiation patterns 500 and 600 of the first planar antenna ANT1 and the second planar antenna ANT2 may be similar, the polarizations of the radiation patterns 500 and 600 are orthogonal to each other, for example, resulting from the 90 degree rotation between ports P1 and P2 of the first planar antenna ANT1 and the second planar antenna ANT2, respectively. The resulting polarization diversity between the first and second planar antennas ANT1-ANT2 may provide the relatively high degree of isolation between corresponding antenna ports P1-P2 that, as depicted in FIG. 4B, may reduce interference between the first and second planar antennas ANT1-ANT2 to a level that allows planar antennas ANT1-ANT2 to simultaneously operate in the same (or similar) frequency bands.

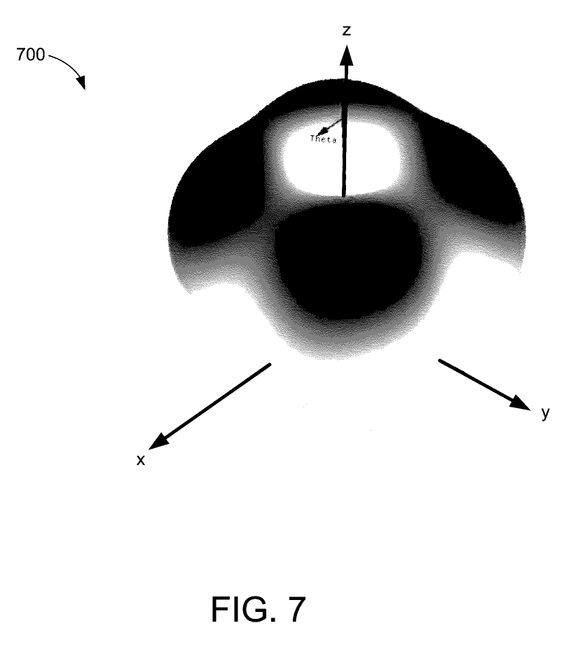

FIG. 7 depicts a three-dimensional radiation pattern 700 of the patch antenna ANT3 of the planar antenna structure 200 of FIGS. 2A-2D. As depicted in FIG. 7, darker regions of pattern 700 correspond to larger gains. Thus, as depicted in FIG. 7, the patch antenna ANT3 has a null in the normal direction (e.g., along the z-axis). For at least some embodiments, the patch antenna ANT3 may have a peak gain of approximately 5.5 dBi and an efficiency of approximately 90% for the 5 GHz band.

Referring also to FIGS. 5-6, because the first and second planar antennas ANT1-ANT2 have peak gains in same direction (e.g., along the z-axis) in which the patch antenna ANT3 has a null, the planar antenna structure 200 provides pattern diversity between the planar antennas ANT1-ANT2 and the patch antenna ANT3. The resulting pattern diversity between the planar antennas ANT1-ANT2 and the patch antenna ANT3 may provide the relatively high degree of isolation between planar antenna ports P1/P2 and patch antenna port P3 that, as depicted in FIG. 4A, may reduce interference between the planar antennas ANT1-ANT2 and the patch antenna ANT3 to a level that allows planar antennas ANT1-ANT2 to simultaneously operate in one frequency band while the patch antenna ANT3 operates in a different frequency band (e.g., thereby allowing for dual-band operation).

As mentioned above, example embodiments of the planar antenna structure 200 may be provided within wireless devices, for example, to allow for the coexistence, in a compact and low-profile structure, of multiple antennas that may simultaneously operate according to one or more wireless communication protocols (e.g., Wi-Fi and Bluetooth) and/or in one or more different frequency bands (e.g., the 2.4 GHz band and the 5 GHz band). The wireless devices that may employ example embodiments of the planar antenna structure 200 may include wireless access points, wireless stations, and/or other wireless communication devices.

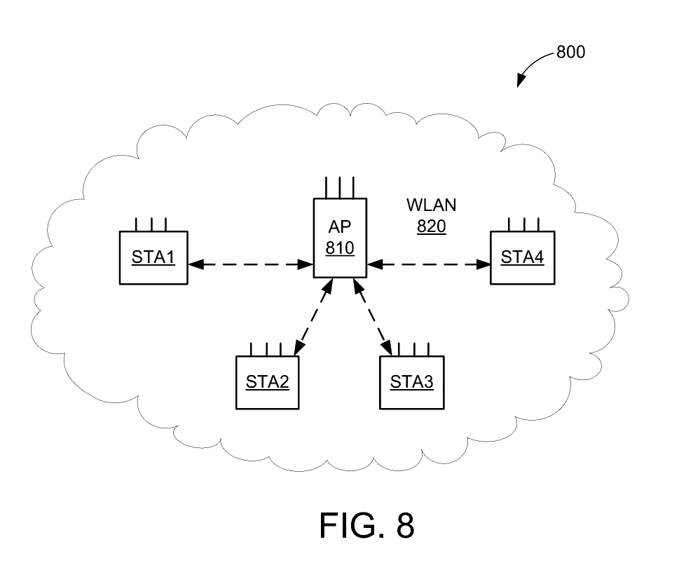

For example, FIG. 8 is a block diagram of a wireless system 800 within which the example embodiments may be implemented. The wireless system 800 is shown to include four wireless stations STA1-STA4, a wireless access point (AP) 810, and a wireless local area network (WLAN) 820. The WLAN 820 may be formed by a plurality of Wi-Fi access points (APs) that may operate according to the IEEE 802.11 family of standards (or according to other suitable wireless protocols). Thus, although only one AP 810 is shown in FIG. 8 for simplicity, it is to be understood that WLAN 820 may be formed by any number of access points such as AP 810. The AP 810 is assigned a unique MAC address that is programmed therein by, for example, the manufacturer of the access point. Similarly, each of STA1-STA4 is also assigned a unique MAC address. For some embodiments, the wireless system 800 may correspond to a multiple-input multiple-output (MIMO) wireless network. Further, although the WLAN 820 is depicted in FIG. 8 as a basic service set (BSS), for other example embodiments, WLAN 820 may be an infrastructure BSS (IBSS), an ad-hoc network, or a peer-to-peer (P2P) network (e.g., operating according to the Wi-Fi Direct protocols).

Each of stations STA1-STA4 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for operating the planar antenna structure 200 of the example embodiments.

The AP 810 may be any suitable device that allows one or more wireless devices to connect to a network (e.g., a local area network (LAN), wide area network (WAN), metropolitan area network (MAN), and/or the Internet) via AP 810 using Wi-Fi, Bluetooth, or any other suitable wireless communication standards or protocols. For at least one embodiment, AP 810 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for operating the planar antenna structure 200 of the example embodiments.

For the stations STA1-STA4 and/or AP 810, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 900 MHz frequency band, a 2.4 GHz frequency band, a 5 GHz frequency band, and/or within a 60 GHz frequency band in accordance with the IEEE 802.11 family of standards. The Bluetooth transceiver may communicate within various RF frequency bands in accordance with the Bluetooth special interest group and/or the IEEE 802.15 family of standards. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the STA may be any technically feasible transceiver such as a ZigBee transceiver described by a specification from the ZigBee specification, a WiGig transceiver, and/or a HomePlug transceiver described a specification from the HomePlug Alliance.

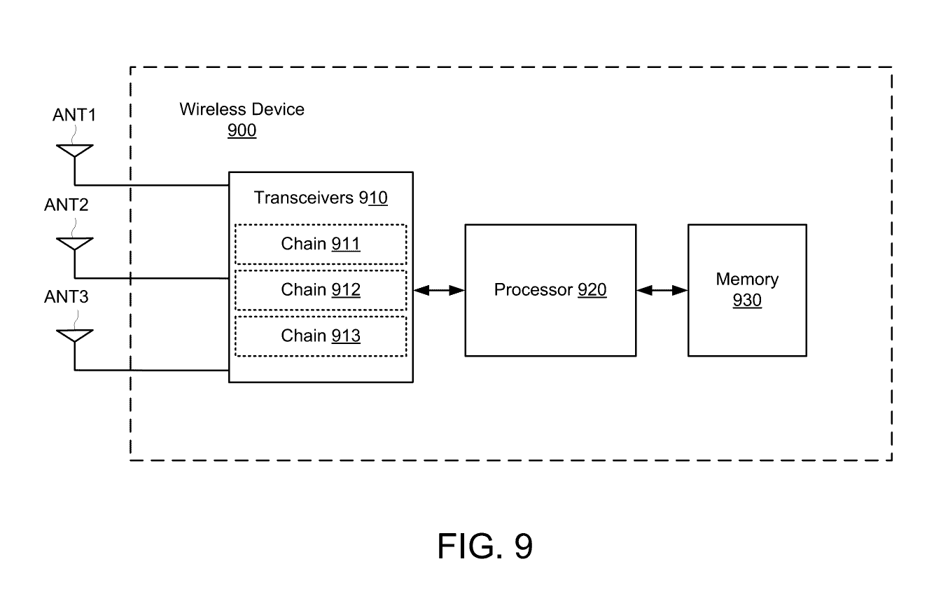

FIG. 9 shows a block diagram of a wireless device 900 in accordance with example embodiments. The wireless device 900 is shown to include a transceiver 910, a processor 920, a memory 930, and the three antennas ANT1-ANT3 of the planar antenna structure 200. Transceiver 910 is shown to include three transceiver chains 911-913. For the example of FIG. 9, the first transceiver chain 911 may be coupled to first planar antenna ANT1, the second transceiver chain 912 may be coupled to second planar antenna ANT2, and the third transceiver chain 913 may be coupled to patch antenna ANT3. Although only three antennas ANT1-ANT3 and three transceiver chains 911-919 are depicted in FIG. 9, wireless device 900 may include additional antenna structures and/or additional transceiver chains. Further, although not shown in FIG. 9 for simplicity, transceiver chains 911-913 may be selectively coupled to antennas ANT1-ANT3 by a suitable antenna selection circuit. For other embodiments, one or more of transceiver chains 911-913 may share one or more of antennas ANT1-ANT3. In addition or as an alternative, one or more of transceiver chains 911-913 may share one or more internal components (not shown for simplicity) such as, for example, local oscillator signals.

The transceiver 910 may be used to communicate with other wireless devices or a WLAN server (not shown) associated with WLAN 820 of FIG. 8 either directly or via one or more intervening networks. The processor 920, which is coupled to transceiver 910 and to memory 930, may be any suitable one or more processors capable of executing scripts or instructions of one or more software programs stored in the device 900 (e.g., within memory 930). The processor 920 may manage radio functions for the wireless device 900 (e.g., to generate signals to be transmitted from wireless device 900 and/or to process signals received by wireless device 900). Memory 930 may include a non-transitory computer-readable medium (e.g., one or more nonvolatile memory elements, such as EPROM, EEPROM, Flash memory, a hard drive, etc.) that may store instructions to be executed by the processor 920.

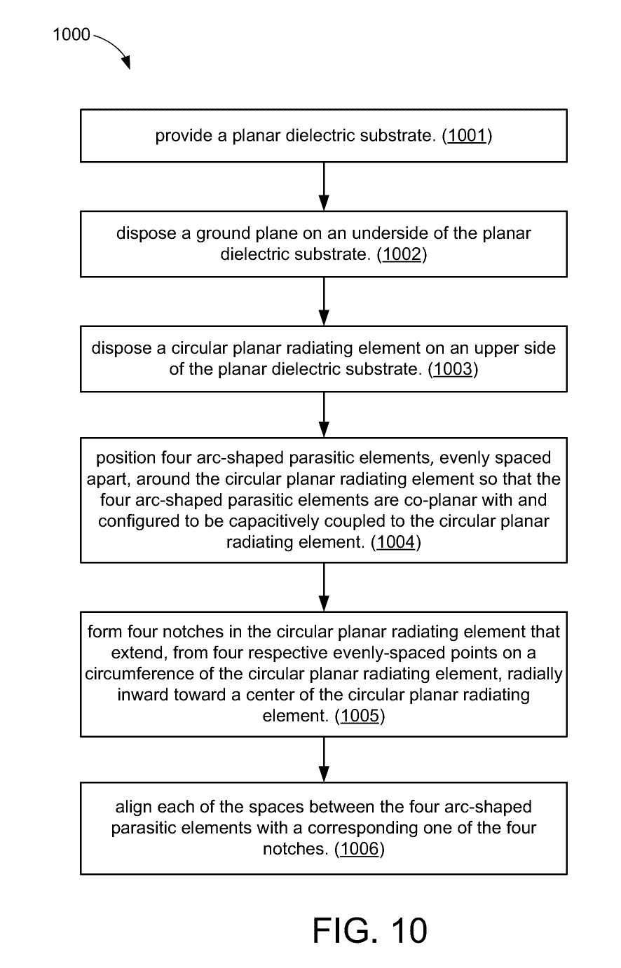

FIG. 10 is an illustrative flow chart 1000 that depicts an example method for constructing one embodiment of the planar antenna structure 200. Referring also to FIGS. 2A-2D, a planar dielectric substrate 201 is first provided (1001). Then, a ground plane 210 is disposed on an underside of the dielectric substrate (1002). Next, a circular planar radiating element 220 is disposed on an upper side of the dielectric substrate 201 (1003). Next, four arc-shaped parasitic elements 230A-230D, evenly spaced apart, are positioned around the circular planar radiating element 220, for example, so that the four arc-shaped parasitic elements 230A-230D are co-planar with and configured to be capacitively coupled to the circular planar radiating element 220 (1004). Next, four notches 221(1)-221(4) are formed in the circular planar radiating element 220, the four notches 221(1)-221(4) extending, from four respective evenly-spaced points 222(1)-222(4) on a circumference of the circular planar radiating element 220, radially inward toward a center of the circular planar radiating element 220 (1005). Then, each of the spaces 231(1)-231(4) between the four arc-shaped parasitic elements 230A-230D is aligned with a corresponding one of the four notches 221(1)-221(4) (1006).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth herein. The specification and drawings are, accordingly, to be regarded in an illustrative sense rather than a restrictive sense.

What is claimed is:

1. An antenna structure, comprising:
a planar dielectric substrate;
a ground plane disposed on an underside of the planar dielectric substrate;
a circular planar radiating element disposed on an upper side of the planar dielectric substrate; and
four arc-shaped parasitic elements evenly spaced apart and surrounding the circular planar radiating element, the four-arc shaped parasitic elements and the circular planar radiating element configured to simultaneously operate together as a first planar antenna, a second planar antenna, and a patch antenna.

2. The antenna structure of claim 1, wherein at least a portion of the circular planar radiating element is shared by the first planar antenna, the second planar antenna, and the patch antenna.

3. The antenna structure of claim 1, wherein a bandwidth of at least one of the antennas is based, at least in part, on a distance between the four arc-shaped parasitic elements and the circular planar radiating element.

4. The antenna structure of claim 1, wherein the first planar antenna, the second planar antenna, and the patch antenna are configured to transmit different wireless signals at the same time.

5. The antenna structure of claim 1, wherein the four arc-shaped parasitic elements are co-planar with and capacitively coupled to the circular planar radiating element.

6. The antenna structure of claim 1, wherein:
a first pair of the arc-shaped parasitic elements operate as opposite end portions of the first planar antenna;
a second pair of the arc-shaped parasitic elements operate as opposite end portions of the second planar antenna; and
all of the arc-shaped parasitic elements operate as peripheral radiating elements of the patch antenna.

7. The antenna structure of claim 1, further comprising:
four notches formed in the circular planar radiating element and extending, from four respective evenly-spaced points on a circumference of the circular planar radiating element, radially inward toward a center of the circular planar radiating element.

8. The antenna structure of claim 7, wherein the circular planar radiating element has a radius of approximately 15 mm, each of the notches radially extends approximately 7 mm into the circular planar radiating element, the spaces between the four arc-shaped parasitic elements each have an angular width of approximately 12 degrees, and the four arc-shaped parasitic elements are separated from the circular planar radiating element by approximately 1 mm.

9. The antenna structure of claim 8, wherein each of the spaces between the four arc-shaped parasitic elements is aligned with a corresponding one of the four notches.

10. The antenna structure of claim 1, wherein:
the first planar antenna is configured to transmit or receive Bluetooth signals;
the second planar antenna is configured to transmit or receive Wi-Fi signals in a first frequency band; and
the patch antenna is configured to transmit or receive Wi-Fi signals in a second frequency band that is different than the first frequency band.

11. The antenna structure of claim 10, wherein the first frequency band comprises a 2.4 GHz band, and the second frequency band comprises a 5 GHz band.

12. An antenna structure, comprising:
a planar dielectric substrate;
a ground plane disposed on an underside of the planar dielectric substrate;
a circular planar radiating element, disposed on an upper side of the planar dielectric substrate, and coupled to a first excitation port, to a second excitation port, and to a third excitation port; and
four arc-shaped parasitic elements surrounding, capacitively coupled to, and coplanar with the circular planar radiating element,
the antenna structure configured to simultaneously transmit first signals received from the first excitation port, to transmit second signals received from the second excitation port, and to transmit third signals received from the third excitation port.

13. The antenna structure of claim 12, wherein the first signals comprise Bluetooth signals, the second signals comprise Wi-Fi signals in a first frequency band, and the third signals comprise Wi-Fi signals in a second frequency band that is different than the first frequency band.

14. The antenna structure of claim 13, wherein the first frequency band comprises a 2.4 GHz band, and the second frequency band comprises a 5 GHz band.

15. The antenna structure of claim 12, wherein the first signals comprise first Wi-Fi signals in a first frequency band, the second signals comprise second Wi-Fi signals in the first frequency band, and the third signals comprise third Wi-Fi signals in a second frequency band that is different than the first frequency band.

16. The antenna structure of claim 12, wherein the circular planar radiating element and the four arc-shaped parasitic elements form a first planar antenna coupled to the first excitation port, form a second planar antenna coupled to the second excitation port, and form a patch antenna coupled to the third excitation port.

17. The antenna structure of claim 16, wherein the first planar antenna and the second planar antenna each have a peak gain in substantially the same direction in which the patch antenna has a null.

18. The antenna structure of claim 12, further comprising:
four notches formed in the circular planar radiating element and extending, from four respective evenly-spaced points on a circumference of the circular planar radiating element, radially inward toward a center of the circular planar radiating element.

19. The antenna structure of claim 18, wherein each of the spaces between the four arc-shaped parasitic elements is aligned with a corresponding one of the four notches.

20. The antenna structure of claim 19, wherein the circular planar radiating element has a radius of approximately 15 mm, each of the notches radially extends approximately 7 mm into the circular planar radiating element, the spaces between the four arc-shaped parasitic elements each have an angular width of approximately 12 degrees, and the four arc-shaped parasitic elements are separated from the circular planar radiating element by approximately 1 mm.

21. A wireless device, comprising:
a number of transceiver chains; and
an antenna structure coupled to the number of transceiver chains, the antenna structure comprising:
a planar dielectric substrate;
a ground plane disposed on an underside of the planar dielectric substrate;
a circular planar radiating element disposed on an upper side of the planar dielectric substrate; and
four arc-shaped parasitic elements evenly spaced apart and surrounding the circular planar radiating element, the four-arc shaped parasitic elements and the circular planar radiating element coplanar with each other and configured to operate together as a first planar antenna, a second planar antenna, and a patch antenna.

22. The wireless device of claim 21, wherein the antenna structure further comprises:
four notches formed in the circular planar radiating element and extending, from four respective evenly-spaced points on a circumference of the circular planar radiating element, radially inward toward a center of the circular planar radiating element.

23. The wireless device of claim 22, wherein each of the spaces between the four arc-shaped parasitic elements is aligned with a corresponding one of the four notches.

24. The wireless device of claim 21, wherein at least a portion of the circular planar radiating element is shared by the first planar antenna, the second planar antenna, and the patch antenna.

25. The wireless device of claim 21, wherein the first planar antenna is configured to transmit Bluetooth signals provided by a first of the transceiver chains, the second planar antenna is configured to transmit 2.4 GHz Wi-Fi signals provided by a second of the transceiver chains, and the patch antenna is configured to transmit 5 GHz Wi-Fi signals provided by a third of the transceiver chains, concurrently.

26. The wireless device of claim 21, wherein the first planar antenna is configured to transmit first 2.4 GHz Wi-Fi signals provided by a first of the transceiver chains, the second planar antenna is configured to transmit second 2.4 GHz Wi-Fi signals provided by a second of the transceiver chains, and the patch antenna is configured to transmit 5 GHz Wi-Fi signals provided by a third of the transceiver chains, concurrently.

27. A method of constructing a planar antenna structure, the method comprising:
providing a planar dielectric substrate;
disposing a ground plane on an underside of the planar dielectric substrate;
disposing a circular planar radiating element on an upper side of the planar dielectric substrate; and
positioning four arc-shaped parasitic elements, evenly spaced apart, around the circular planar radiating element so that the four arc-shaped parasitic elements are co-planar with and configured to be capacitively coupled to the circular planar radiating element, the four-arc shaped parasitic elements and the circular planar radiating element configured to simultaneously operate together as a first planar antenna, a second planar antenna, and a patch antenna.

28. The method of claim 27, wherein at least a portion of the circular planar radiating element is shared by the first planar antenna, the second planar antenna, and the patch antenna.

29. The method of claim 27, further comprising:
forming four notches in the circular planar radiating element that extend, from four respective evenly-spaced points on a circumference of the circular planar radiating element, radially inward toward a center of the circular planar radiating element.

30. The method of claim 29, wherein each of the spaces between the four arc-shaped parasitic elements is aligned with a corresponding one of the four notches.
